(19) United States
(12) Patent Application Publication
(10) Pub. No.: US 2019/0058896 A1
(43) Pub. Date: Feb. 21, 2019

(54) METHOD AND APPARATUS OF VIDEO CODING WITH AFFINE MOTION COMPENSATION

(71) Applicant: MEDIATEK INC., Hsin-Chu (TW)

(72) Inventors: Han HUANG, Beijing City (CN); Kai ZHANG, Beijing City (CN); Jicheng AN, Beijing City (CN)

(73) Assignee: MEDIATEK INC., Hsin-Chu (TW)

(21) Appl. No.: 16/079,166

(22) PCT Filed: Feb. 27, 2017
(86) PCT No.: PCT/CN2017/074965

§ 371 Date: Aug. 23, 2018

(30) Foreign Application Priority Data
Mar. 1, 2016 (CN) PCT/CN2016/075024

(51) Int. Cl. H04N 19/517; H04N 19/61; H04N 19/105; H04N 19/159; H04N 19/30; H04N 19/176

(52) U.S. Cl. CPC H04N 19/517; H04N 19/61; H04N 19/176; H04N 19/159; H04N 19/30; H04N 19/105

(57) ABSTRACT

An encoding or decoding method with affine motion compensation includes receiving input data associated with a current block in a current picture, and deriving a first affine candidate for the current block including three affine motion vectors for predicting motion vectors at control points of the current block if the current block is coded or to be coded in affine Merge mode. The affine motion vectors are derived from three different neighboring coded blocks of the current block. An affine motion model is derived according to the affine motion vectors if the first affine candidate is selected. Moreover, the method includes encoding or decoding the current block by locating a reference block in a reference picture according to the affine motion model. The current block is restricted to be coded in uni-directional prediction if the current block is coded or to be coded in affine Inter mode.

### CROSS REFERENCE TO RELATED APPLICATIONS

The present invention claims priority to PCT Patent Application Serial No. PCT/CN2016/075024, filed on Mar. 1, 2016, entitled “Methods for Affine Motion Compensation”. The PCT Patent Application is hereby incorporated by reference in its entirety.

### TECHNICAL FIELD

The present invention relates to image and video coding with affine motion compensation. In particular, the present invention relates to techniques to improve the coding efficiency or reduce the complexity of a video coding system implementing various coding modes including an affine mode.

### BACKGROUND

In most coding standards, adaptive coding and Inter/Intra prediction are applied on a block basis. For example the basic block unit for video coding in the High Efficiency Video Coding (HEVC) system is called coding unit (CU). A CU may begin with a largest CU (LCU), which is also referred as coded tree unit (CTU). Once each LCU is recursively partitioned into leaf CUs, each leaf CU is further split into one or more prediction units (PUs) according to a prediction type and a PU partition mode. Pixels in a PU share the same prediction parameters.

For a current block processed by Inter prediction mode, block matching may be used to locate a reference block in a reference picture. The displacement between locations of the two blocks is determined as a motion vector (MV) for the current block. HEVC supports two different types of Inter prediction mode, one is advanced motion vector prediction (AMVP) mode and another is Merge mode. The MV of the current block is predicted by a motion vector predictor (MVP) corresponds to motion vector associated with spatial and temporal neighbors of the current block. A motion vector difference (MVD) between the MV and the MVP, as well as an index of the MVP are coded and transmitted for the current block coded in AMVP mode. In B slice, a syntax element inter_pred_idc is used to indicate the inter prediction direction. One MV is used to locate a predictor for the current block if the current block is coded in uni-directional prediction, while two MVs are used to locate predictors if the current block is coded in bi-directional prediction, so two MVDs and two indices of MVP are signaled for blocks coded in bi-directional prediction. In the case of multiple reference pictures, a syntax element ref_idx_10 is signaled to indicate which reference picture in list 0 is used, and a syntax element ref_idx_11 is signaled to indicate which reference picture in list 1 is used. In Merge mode, motion information of a current block including MV, reference picture index, and inter prediction direction is inherited from motion information of a final Merge candidate selected from a Merge candidate list. The Merge candidate list is constructed by motion information of spatially and temporally neighboring blocks of the current block, and a Merge index is signaled to indicate the final Merge candidate.

The block based motion compensation in HEVC assumes all pixels within a PU follow the same translational motion model by sharing the same motion vector; however, the translational motion model cannot capture complex motion such as rotation, zooming, and the deformation of moving objects. An affine transform model introduced in the literature provides more accurate motion-compensated prediction as the affine transform model is capable of describing two-dimensional block rotations as well as two-dimensional deformations to transform a rectangle into a parallelogram. This model can be described as follows:

x′=a*x+b*y+e, and

y′=c*x+d*y+f. (1)

where A(x,y) is an original pixel at location (x,y) under consideration, and A′ (x′,y′) is the corresponding pixel at location (x′,y′) in a reference picture for the original pixel A(x,y). A total of six parameters a, b, c, d, e, f, are used in this affine transform model, and this affine transform model describes the mapping between original locations and reference locations in six-parameter affine prediction. For each original pixel A(x,y), the motion vector (vx, vy) between this original pixel A(x,y) and its corresponding reference pixel A′(x′y′) is derived as:

vx=(1−a)*x−b*y−e, and

vy=(1−c)*x−d*y−f. (2)

The motion vector (vx, vy) of each pixel in the block is location dependent and can be derived by the affine motion model present in Equation (2) according to its location (x,y).

FIG. 1A illustrates an example of motion compensation according to an affine motion model, where a current block 102 is mapped to a reference block 104 in a reference picture. The correspondences between three corner pixels 110, 112, and 114 of the current block 102 and three corner pixels of the reference block 104 can be determined by the three arrows as shown in FIG. 1A. The six parameters for the affine motion model can be derived based on three known motion vectors Mv0, Mv1, Mv2 of the three corner pixels. The three corner pixels 110, 112, and 114 are also referred as the control points of the current block 102. Parameter derivation for the affine motion model is known in the field and the details are omitted here.

Various implementations of affine motion compensation have been disclosed in the literature. For example, sub-block based affine motion model is applied to derive a MV for each sub-block instead of each pixel to reduce the complexity of affine motion compensation. In a technical paper by Li el at. (“An Affine Motion Compensation Framework for High Efficiency Video Coding”, 2015 IEEE International Symposium on Circuits and Systems (ISCAS), May 2015, pages: 525-528), an affine flag is signaled for each 2N×2N block partition to indicate the use of affine motion compensation when the current block is coded either in Merge mode or AMVP mode. If this flag is true, the derivation of motion vectors for the current block follows the affine motion model, else the derivation of a motion vector for the current block follows the traditional translational motion model. Three MVs of three corner pixels are signaled when affine Inter mode (also known as affine AMVP mode or AMVP affine mode) is used. At each control point location, the MV is predictively coded by signaling a MVD of the control point. In another exemplary implementation, an affine flag is conditionally signaled depending on Merge candidates when the current block is coded in Merge mode. The affine flag indicates whether the current block is coded in affine Merge mode. The affine flag is only signaled when there is at least one Merge candidate being affine coded, and the first available affine coded Merge candidate is selected if the affine flag is true.

A four-parameter affine prediction is an alternative to the six-parameter affine prediction, which has two control points instead of three control points. An example of the four-parameter affine prediction is shown in FIG. 1B. Two control points 130 and 132 are located at the upper-left and upper-right corners of a current block 122, and motion vectors Mv0 and Mv1 map the current block 122 to a reference block 124 in a reference picture.

### SUMMARY

A method and apparatus for video encoding and decoding with affine motion compensation in a video coding system are disclosed. Embodiments of a video encoder or decoder according to the present invention receive input data associated with a current block in a current picture, and derive a first affine candidate for the current block if the current block is coded or to be coded in affine Merge mode. The input data associated with the current block includes a set of pixels at the video encoder side or the input data associated with the current block is a video bitstream corresponding to compressed data including the current block at the video decoder side The first affine candidate includes three affine motion vectors Mv0, Mv1, and Mv2 for predicting motion vectors at control points of the current block. Mv0 is derived from a motion vector of a first neighboring coded block of the current block, Mv1 is derived from a motion vector of a second neighboring coded block of the current block, and Mv2 is derived from a motion vector of a third neighboring coded block of the current block. An affine motion model is then derived according to the affine motion vectors Mv0, Mv1, and Mv2 of the first affine candidate if the first affine candidate is selected to encode or decode the current block. The current block is encoded or decoded by locating a reference block in a reference picture for the current block according to the affine motion model.

In an embodiment, the three neighboring coded blocks are an upper-left corner sub-block adjacent to the current block, a top-right sub-block above the current block, and a left-bottom sub-block beside the current block. In another embodiment, each of the affine motion vectors Mv0, Mv1, and Mv2 is a first available motion vector selected from a predetermined group of motion vectors of neighboring coded blocks. For example, Mv0 is a first available motion vector of motion vectors at an upper-left corner sub-block adjacent to the current block, a top-left sub-block above the current block, and a left-top sub-block beside the current block. Mv1 is a first available motion vector of motion vectors at a top-right sub-block above the current block and an upper-right corner sub-block adjacent to the current block. Mv2 is a first available motion vector of motion vectors at a left-bottom sub-block beside the current block and a lower-left corner sub-block adjacent to the current block.

In some embodiments, multiple affine candidates are used in affine Merge mode. For example, a second affine candidate including three affine motion vectors are also derived and inserted in a Merge candidate list, and if the second affine candidate is selected to encode or decode the current block, deriving the affine motion model according to the affine motion vectors of the second affine candidate. At least one affine motion vector in the second affine candidate is different from the corresponding affine motion vector in the first affine candidate.

An embodiment of the video encoder or decoder denotes the first affine candidate as not exist or unavailable if inter prediction directions or reference pictures of the three affine motion vectors Mv0, Mv1, and Mv2 are not all the same. The video encoder or decoder may derive a new affine candidate to replace the first affine candidate. If all the three affine motion vectors Mv0, Mv1, and Mv2 are available only in the first reference list, an inter prediction direction for the current block is set to uni-directional predicted and using only a first reference list. The first reference list is selected from list 0 and list 1. If reference pictures of the three affine motion vectors are not all the same, an embodiment scales the affine motion vectors Mv0, Mv1, and Mv2 in the first affine candidate to a designated reference picture; or if two affine motion vectors correspond to a same reference picture, the method scales the remaining affine motion vectors in the first affine candidate to set all reference pictures of the three affine motion vectors the same.

Aspects of the disclosure further provide a video encoder or decoder receives input data associated with a current block in a current picture, and derives an affine candidate for the current block if the current block is coded or to be coded in affine Inter mode. The affine candidate includes multiple affine motion vectors for predicting motion vectors at control points of the current block, and the affine motion vectors are derived from one or more neighboring coded blocks. If the affine candidate is selected to encode or decode the current block, the encoder or decoder derives an affine motion model according to the affine motion vectors of the affine candidate, and encodes or decodes the current block by locating a reference block in a current reference picture according to the affine motion model. The current reference picture is pointed by a reference picture index, and the current block is restricted to be coded in uni-directional prediction by disabling bi-directional prediction if the current block is coded or to be coded in affine Inter mode. The affine motion model computes motion based on three control points or a simplified affine motion model can be used which computes motion based on only two control points. In an embodiment, there is only one affine candidate in the candidate list, so the affine candidate is selected without signaling a motion vector predictor (MVP) index.

In some embodiments, one or more of the affine motion vectors in the affine candidate are scaled to the current reference picture pointed by the reference picture index if reference pictures of said one or more affine motion vectors are not the same as the current reference picture. An inter prediction direction flag is signaled to indicate a selected reference list if reference list 0 and reference list 1 of the current block are not the same, and the inter prediction direction flag is not signaled if reference list 0 and reference list 1 of the current block are the same.

Aspects of the disclosure further provide a non-transitory computer readable medium storing program instructions for causing a processing circuit of an apparatus to perform a video coding method with affine motion compensation. The video coding method includes encoding or decoding a current block according to an affine candidate including affine motion vectors derived from multiple neighboring coded blocks of the current block. The video coding method includes disabling bi-directional prediction for blocks coded or to be coded in affine Inter mode. Other aspects and features of the invention will become apparent to those with ordinary skill in the art upon review of the following descriptions of specific embodiments.

### BRIEF DESCRIPTION OF DRAWINGS

Various embodiments of this disclosure that are proposed as examples will be described in detail with reference to the following figures, wherein like numerals reference like elements, and wherein:

FIG. 1A illustrates six-parameter affine prediction mapping a current block to a reference block according to three control points.

FIG. 1B illustrates four-parameter affine prediction mapping a current block to a reference block according to two control points.

FIG. 2 illustrates an example of deriving one or more affine candidates based on neighboring coded blocks.

FIG. 3 is a flowchart illustrating an embodiment of the affine Merge prediction method.

FIG. 4 illustrates an exemplary system block diagram for a video encoder with affine prediction according to an embodiment of the present invention.

FIG. 5 illustrates an exemplary system block diagram for a video decoder with affine prediction according to an embodiment of the present invention.

FIG. 6 is a flowchart illustrating an embodiment of the affine Inter prediction method.

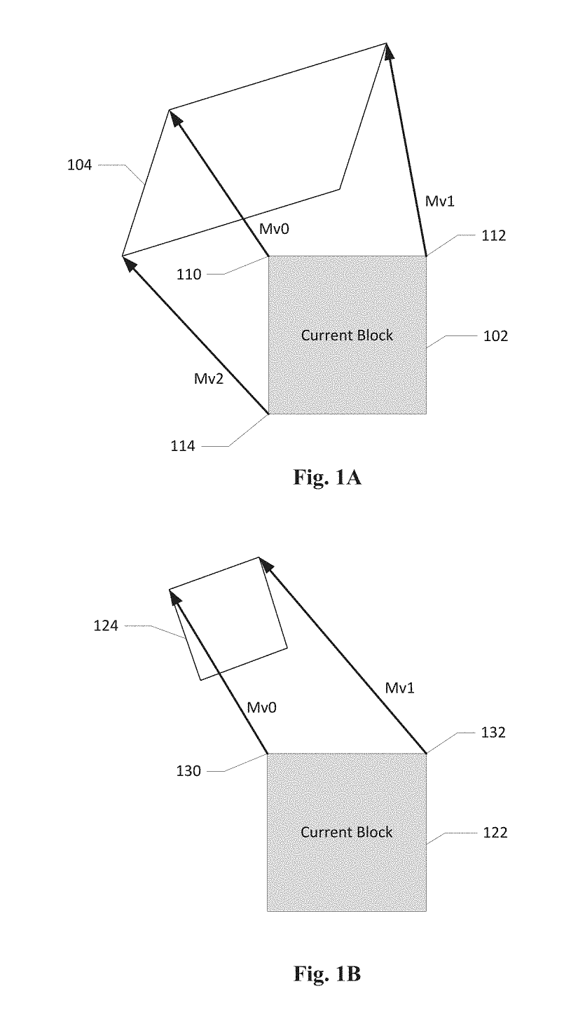

### DETAILED DESCRIPTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. In the following discussion and in the claims, the term “including” and “comprising” are used in an open-ended fashion, and thus should be interpreted to mean “including, but not limited to . . . ”.

In order to improve the coding efficiency or reduce the system complexity associated with a video coding system with affine motion prediction, various methods and improvements of utilizing affine motion compensation in affine Merge mode or affine Inter mode are disclosed.

Affine Motion Derivation

An embodiment of the present invention demonstrates an improved affine motion derivation for sub-block based or pixel-based affine motion compensation. A first exemplary affine motion derivation method is for sub-block based six-parameter affine motion prediction with three control points, one at the upper-left corner, one at the upper-right corner, and one at the lower-left corner. Given three affine motion vectors Mv0, Mv1, and Mv2 representing motion vectors at the three control points of a current block denoted as: Mv0=(Mvx0, Mvy0), Mv1=(Mvx1, Mvy1), and Mv2=(Mvx2, Mvy2).

The current block has a width equals to BlkWidth and a height equals to BlkHeight, and is partitioned into sub-blocks, where each sub-block has a width equals to SubWidth and a height equals to SubHeight. The number of sub-blocks M in one row of the current block is M=BlkWidth/SubWidth, and the number of sub-blocks N in one column of the current block is N=BlkHeight/SubHeight. MV of a sub-block Mv(i,j) at i^{th} sub-block column and j^{th} sub-block row is (Mvx(i,j), Mvy(i,j)), where i=0, . . . , N−1, and j=0, . . . , M−1, is derived as:

Mvx(i,j)=Mvx0+(i+1)*deltaMvxVer+(j+1)*deltaMvxHor, and

Mvy(i,j)=Mvy0+(i+1)*deltaMvyVer+(j+1)*deltaMvyHor. (3)

where deltaMvxHor, deltaMvyHor, deltaMvxVer, deltaMvyVer are calculated as:

deltaMvxHor=(Mvx1−Mvx0)/M,

deltaMvyHor=(Mvy1-Mvy0)/M,

deltaMvxVer=(Mvx2−Mvx0)/N, and

deltaMvyVer=(Mvy2−Mvy0)/N. (4)

In another embodiment, MV of a sub-block Mv(i,j) at i^{th} sub-block column and j^{th} sub-block row is (Mvx(i,j), Mvy(i,j)), where i=0, . . . , N−1, and j=0, . . . , M−1, is derived as:

Mvx(i,j)=Mvx0+i*deltaMvxVer+j*deltaMvxHor, and

Mvy(i,j)=Mvy0+i*deltaMvyVer+j*deltaMvyHor. (5)

For applying the first exemplary affine motion derivation method to a pixel-based affine prediction, definitions for M and N in Equation (4) can be modified to represent the number of pixels in one row of the current block and the number of pixels in one column of the current block, in this case, M=BlkWidth and N=BlkHeight. The motion vector Mv(i,j) of each pixel at location (i,j) is (Mvx(i,j), Mvy(i,j)), and the motion vector at each pixel can also be derived by Equation (3) or Equation (5).

For a current block coded or to be coded in affine Inter mode or affine Merge mode, a final candidate is selected for predicting motions of the current block. The final candidate includes three affine motion vectors Mv0, Mv1 and Mv2 for predicting motions of the three control points of the current block. A motion vector at each pixel or each sub-block of the current block is calculated using the affine motion derivation method described in the embodiments of the present invention. A reference block in a reference picture is located according to the motion vectors of the current block and the reference block is used to encode or decode the current block.

Affine Merge Candidate Derivation

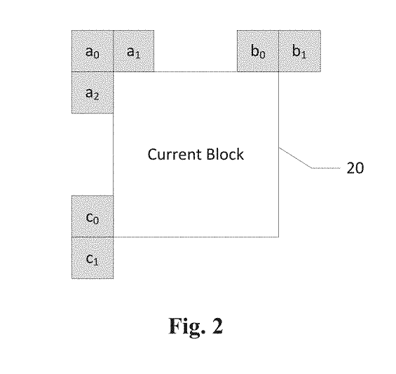

FIG. 2 illustrates an example of deriving an affine candidate based on neighboring coded blocks. A conventional affine Merge candidate derivation method checks neighboring coded blocks a₀ (referred as the upper-left corner block), b₀ (referred as the top-right block), b₁ (referred as the upper-right corner block), c₀ (referred as the left-bottom block), and c₁ (referred as the lower-left corner block) in a predetermined order and determines whether any of the neighboring coded blocks is coded in affine Inter mode or affine Merge mode when a current block 20 is a Merge coded block. An affine flag is signaled to indicate whether the current block 20 is in affine mode only if any of the neighboring coded blocks is coded in affine Inter mode or affine Merge mode. When encoding or decoding the current block 20 in affine Merge mode, the first available affine-coded block is selected from the neighboring coded blocks. The selection order for the affine-coded block is from left-bottom block, top-right block, upper-right corner block, lower-left corner block to upper-left corner block (c₀→b₀→b₁→c₁→a₀) as shown in FIG. 2. The affine motion vectors of the first available affine-coded block are used to derive the motion vectors for the current block 20.

In some embodiments of the affine Merge candidate derivation method according to the present invention, the affine motion vectors Mv0, Mv1, and Mv2 of a single affine Merge candidate are derived from multiple neighboring coded blocks of a current block 20, for examples, Mv0 is derived from a top-left neighboring sub-block (sub-block a₀, a₁, or a₂ in FIG. 2), Mv1 is derived from a top-right neighboring sub-block (sub-block b₀ or b₁), and Mv2 is derived from a bottom-left neighboring sub-block (sub-block c₀ or c₁). The affine motion vectors is a set of motion vector predictors (MVPs) predicting the motion vector at three control points of the current block 20. The sub-block is not necessary to be an individually coded block (i.e. a PU in HEVC), it can be a portion of the coded block. For example, the sub-block is a portion of an affine-coded block next to the current block, or the sub-block is an AMVP-coded block. In one embodiment, as shown in FIG. 2, Mv0 is derived from an upper-left corner sub-block (a₀), Mv1 is derived from a top-right sub-block (b₀), and Mv2 is derived from a left-bottom sub-block (c₀). In another embodiment, affine motion vector Mv0 is a first available motion vector at sub-block a₀, a₁, or a₂, affine motion vector Mv1 is a first available motion vector at sub-block b₀ or b₁, and affine motion vector Mv2 is a first available motion vector at sub-block c₀ or c₁. The derived affine Merge candidate is inserted into a Merge candidate list, and a final Merge candidate is selected from the Merge candidate list for encoding or decoding the current block.

Another embodiment of the affine Merge candidate derivation method constructs multiple affine Merge candidates and inserts the affine Merge candidates to the Merge candidate list. For example, a first affine Merge candidate includes affine motion vectors Mv0, Mv1, and Mv2, where Mv0 is a motion vector at sub-block a₀ in FIG. 2, Mv1 is a motion vector at sub-block b₀, and Mv2 is a motion vector at sub-block c₀. A second affine Merge candidate includes affine motion vectors Mv0, Mv1, and Mv2, where Mv0 is a motion vector at sub-block a₀, Mv1 is a motion vector at sub-block b₀, and Mv2 is a motion vector at sub-block c₁. The first and second affine Merge candidates in this example only differ in Mv2. A third affine Merge candidate includes affine motion vectors Mv0, Mv1, and Mv2, where Mv0 is a motion vector at sub-block a₀, Mv1 is a motion vector at sub-block b₁, and Mv2 is a motion vector at sub-block c₀. The first and third affine Merge candidates in this example only differ in Mv1. A fourth affine Merge candidate includes affine motion vectors Mv0, Mv1, and Mv2, where Mv0 is a motion vector at sub-block a₀, Mv1 is a motion vector at sub-block b₁, and Mv2 is a motion vector at sub-block c₁. The first and fourth affine Merge candidates in this example differ in Mv1 and Mv2. The first affine motion vector Mv0 in the previous example can be replaced by the motion vector at a top-left sub-block (a₁) or left-top sub-block (a₂). In one embodiment, the first motion vector Mv0 is derived from sub-block a₁ or sub-block a₂ if the motion vector is invalid or unavailable at the upper-left corner sub-block (a₀). For an example of constructing two affine Merge candidates for a current block, the two affine Merge candidate can be selected from any two of the first, second, third, and fourth affine Merge candidates in the previous example. In one embodiment, the construction of two affine Merge candidates can be the first two candidates available from the first, second, third and fourth affine Merge candidates in the previous example. The current block has a greater chance to be coded in affine Merge mode by increasing the number of affine Merge candidates in the Merge candidate list, which effectively improves the coding efficiency of the video coding system with affine motion compensation.

There are various modifications to improve the affine Merge candidate derivation method. A modification is to check whether inter prediction directions of the three affine motion vectors in the affine Merge candidate are the same, if the inter prediction directions are not all the same, this affine Merge candidate is denoted as not exist or unavailable. In one embodiment, a new affine Merge candidate is derived to replace this affine Merge candidate. Another modification is to check the availability of reference list 0 and reference list 1, and set the inter prediction direction of the current block accordingly. For example, if all three affine motion vectors Mv0, Mv1, and Mv2 are only available in reference list 0, then the current block is coded or to be coded in uni-directional prediction and using only reference list 0. If all three affine motion vectors Mv0, Mv1, and Mv2 are only available in reference list 1, then the current block is coded or to be coded in uni-directional prediction and using only reference list 1. A third modification is to check whether reference pictures of the affine motion vectors Mv0, Mv1, and Mv2 are different, if the reference pictures are not all the same, one embodiment is to denote the affine Merge candidate as not exist or as unavailable, another embodiment is to scale all the affine motion vectors to a designated reference picture, such as the reference picture with a reference index 0. If out of the three reference pictures of the affine motion vectors, two reference pictures are the same, the affine motion vector with a different reference picture can be scaled to the same reference picture.

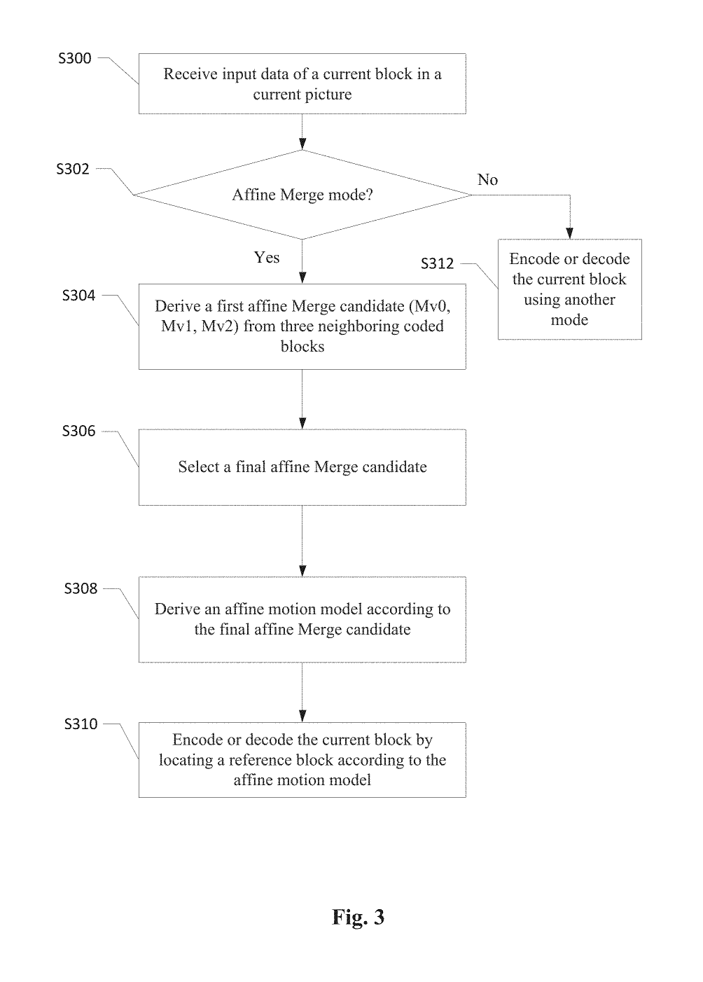

FIG. 3. Illustrates an exemplary flowchart for a video coding system with an affine Merge mode incorporating an embodiment of the present invention, where the system derives an affine Merge candidate from three different neighboring coded blocks. The input data related to a current block is received at a video encoder side or a video bitstream corresponding to compressed data including the current block is received at a video decoder side in step 300. Step 302 checks if the current block is coded or to be coded in affine Merge mode, and if no, the current block is encoded or decoded according to another mode in step 312. A first affine Merge candidate (Mv0, Mv1, Mv2) is derived from three neighboring coded blocks in step 304, for example, a first affine motion vector Mv0 is derived from a motion vector at an upper-left corner sub-block adjacent to the current block, a second affine motion vector Mv1 is derived from a motion vector at a top-right sub-block above the current block, and a third affine motion vector Mv2 is derived from a motion vector at a left-bottom sub-block on the left side of the current block. A final affine Merge candidate is selected from a Merge candidate list in step 306, and an affine motion model is derived according to the final affine Merge candidate in step 308. The current block is then encoded or decoded by locating a reference block according to the affine motion model in step 310.

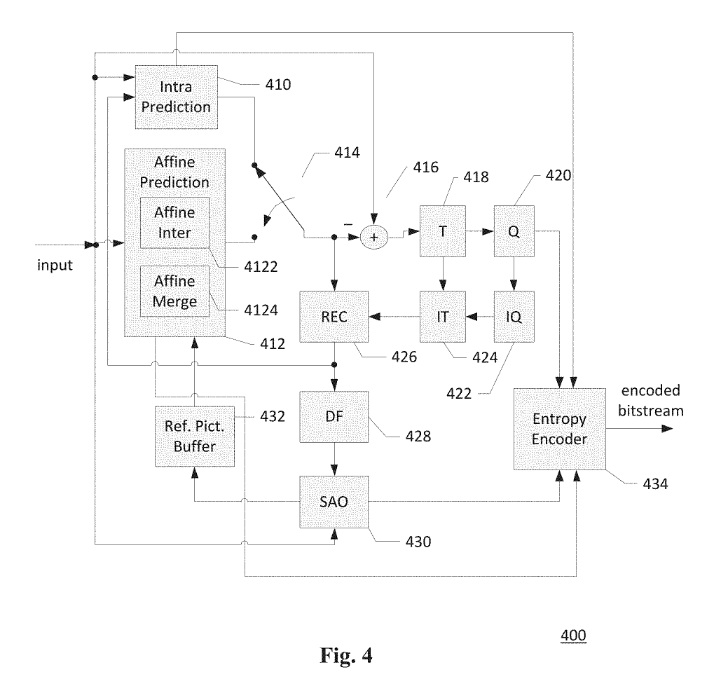

FIG. 4 illustrates an exemplary system block diagram for a Video Encoder 400 based on High Efficiency Video Coding (HEVC) with affine motion compensation according to an embodiment of the present invention. Intra Prediction 410 provides intra predictors based on reconstructed video data of a current picture, whereas Affine Prediction 412 performs motion estimation (ME) and motion compensation (MC) to provide predictors based on video data from other picture or pictures. Each block in the current picture processed by Affine Prediction 412 selects to be encoded in affine Inter mode by Affine Inter Prediction 4122 or to be encoded in affine Merge mode by Affine Merge prediction 4124. For a block encoded in affine Inter mode or affine Merge mode, a final affine candidate is selected to locate a reference block using an affine motion model derived by the final affine candidate, and the reference block is used to predict the block. The Affine Merge Prediction 4124 constructs one or more affine Merge candidates according to motion vectors of multiple neighboring coded blocks and inserts the one or more affine Merge candidates in a Merge candidate list. Affine Merge mode allows the inheritance of affine motion vectors at control points from the neighboring coded blocks; therefore motion information is only signaled by a merge index. The merge index for selecting the final affine candidate is then signaled in an encoded video bitstream. For a block coded in affine Inter mode, motion information such as Motion vector difference (MVD) between the affine motion vectors in the final affine candidate and motion vectors at control points of the block are coded in the encoded video bitstream. Switch 414 selects one of the outputs from Intra Prediction 410 and Affine Prediction 412 and supplies the selected predictor to Adder 416 to form prediction errors, also called prediction residual signal.

The prediction residual signal is further processed by Transformation (T) 418 followed by Quantization (Q) 420. The transformed and quantized residual signal is then coded by Entropy Encoder 434 to form the encoded video bitstream. The encoded video bitstream is then packed with side information such as the motion information. The data associated with the side information are also provided to Entropy Encoder 434. When motion compensation prediction mode is used, a reference picture or pictures have to be reconstructed at the encoder end as well. The transformed and quantized residual signal is processed by Inverse Quantization (IQ) 422 and Inverse Transformation (IT) 424 to recover the prediction residual signal of the reference picture or pictures. As shown in FIG. 4, the prediction residual signal is recovered by adding back to the selected predictor at Reconstruction (REC) 426 to produce reconstructed video data. The reconstructed video data may be stored in Reference Picture Buffer (Ref. Pict. Buffer) 432 and used for prediction of other pictures. The reconstructed video data from REC 426 may be subject to various impairments due to the encoding processing, consequently, in-loop processing Deblocking Filter (DF) 428 and Sample Adaptive Offset (SAO) 430 is applied to the reconstructed video data before storing in the Reference Picture Buffer 432 to further enhance picture quality. DF information from DF 428 and SAO information from SAO 430 are also provided to Entropy Encoder 434 for incorporation into the encoded video bitstream.

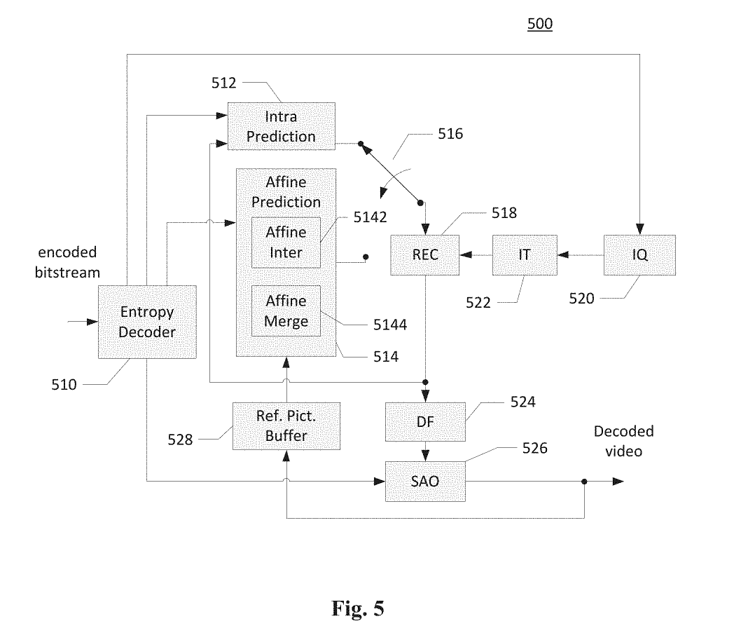

A corresponding Video Decoder 500 for the Video Encoder 400 of FIG. 4 is shown in FIG. 5. The encoded video bitstream is the input to the Video Decoder 500 and is decoded by Entropy Decoder 510 to recover the transformed and quantized residual signal, DF and SAO information, and other system information. The decoding process of Decoder 500 is similar to the reconstruction loop at the Encoder 400, except Decoder 500 only requires motion compensation prediction in Affine Prediction 514. Affine Prediction 514 includes Affine Inter Prediction 5142 and Affine Merge Prediction 5144. Blocks coded in affine Inter mode is decoded by Affine Inter Prediction 5142 and blocks coded in affine Merge mode is decoded by Affine Merge Prediction 5144. A final affine candidate is selected for a block coded in affine Inter mode or affine Merge mode, and a reference block is located according to the final affine candidate. Switch 516 selects intra predictor from Intra Prediction 512 or affine predictor from Affine Prediction 514 according to decoded mode information. The transformed and quantized residual signal is recovered by Inverse Quantization (IQ) 520 and Inverse Transformation (IT) 522. The recovered transformed and quantized residual signal is reconstructed by adding back the predictor in REC 518 to produce reconstructed video. The reconstructed video is further processed by DF 524 and SAO 526 to generate final decoded video. If the currently decoded picture is a reference picture, the reconstructed video of the currently decoded picture is also stored in Ref. Pict. Buffer 528.

Various components of the Video Encoder 400 and the Video Decoder 500 in FIG. 4 and FIG. 5 may be implemented by hardware components, one or more processors configured to execute program instructions stored in a memory, or a combination of hardware and processor. For example, a processor executes program instructions to control receiving of input data associated with a current block. The processor is equipped with a single or multiple processing cores. In some examples, the processor executes program instructions to perform functions in some components in the Encoder 400 and the Decoder 500, and the memory electrically coupled with the processor is used to store the program instructions, information corresponding to the affine modes, reconstructed images of blocks, and/or intermediate data during the encoding or decoding process. The memory in some embodiment includes a non-transitory computer readable medium, such as a semiconductor or solid-state memory, a random access memory (RAM), a read-only memory (ROM), a hard disk, an optical disk, or other suitable storage medium. The memory may also be a combination of two or more of the non-transitory computer readable medium listed above. As shown in FIGS. 4 and 5, the Encoder 400 and the Decoder 500 may be implemented in the same electronic device, so various functional components of the Encoder 400 and Decoder 500 may be shared or reused if implemented in the same electronic device. For example, one or more of Reconstruction 426, Transformation 418, Quantization 420, Deblocking Filter 428, Sample Adaptive Offset 430, and Reference Picture Buffer 432 in FIG. 4 may also be used to function as Reconstruction 518, Transformation 522, Quantization 520, Deblocking Filter 524, Sample Adaptive Offset 526, and Reference Picture Buffer 528 in FIG. 5, respectively. In some example, a portion of Intra Prediction 410 and Affine Prediction 412 in FIG. 4 may share or reused a portion of Intra Prediction 512 and Affine Prediction 514 in FIG. 5.

Affine Inter Prediction

If a current block is coded in affine Inter mode, a candidate list is constructed using neighboring valid coded blocks. As shown in FIG. 2, an affine candidate includes three affine motion vectors Mv0, Mv1, and Mv2. Affine motion vector Mv0 at an upper-left control point of a current block 20 is derived from one of motion vectors of neighboring sub-block a₀ (referred as the upper-left corner sub-block), a₁ (referred as the top-left sub-block), and a₂ (referred as the left-top sub-block). Affine motion vector Mv1 at an upper-right control point of the current block 30 is derived from one or motion vectors of neighboring sub-block b₀ (referred as the top-right sub-block) and b₁ (referred as the upper-right corner sub-block). Affine motion vector Mv2 at a lower-left control point of the current block 20 is derived from one of motion vectors of neighboring sub-block c₀ (referred as the left-bottom sub-block) and c₁ (referred as the lower-left corner sub-block). For example, Mv0 is derived from the motion vector at neighboring sub-block a₀, Mv1 is derived from the motion vector at neighboring sub-block b₀, and Mv2 is derived from the motion vector at neighboring sub-block c₀. In another example, Mv0 is the first available motion vector at neighboring sub-blocks a₀, a₁, and a₂, Mv1 is the first available motion vector at neighboring sub-blocks at 1)₀ and b₁, and Mv2 is the first available motion vector at neighboring sub-blocks at c₀ and c₁.

In some embodiments of affine Inter prediction, there is only one candidate in the candidate list, so the affine candidate is always selected without signaling a motion vector predictor (MVP) index when affine Inter mode is selected to encode or decode the current block. Motions in the current block are derived by an affine motion model according to the affine motion vectors in the affine candidate and a reference block is located by the motion vectors of the current block. If a reference picture of a neighboring coded block used to derive the affine motion vector is not the same as the current reference picture of the current block, the affine motion vector is derived by scaling the corresponding motion vector of the neighboring code block.

According to some embodiments of the affine Inter prediction, only uni-directional prediction is allowed for blocks coded in affine Inter mode to reduce the system complexity. In other words, bi-directional prediction is disabled when a current block is coded or to be coded in affine Inter mode. Bi-directional prediction may be enabled when the current block is coded in affine Merge mode, Merge mode, AMVP mode or any combination thereof. In an embodiment, when reference list 0 and reference list 1 for the current block are the same, reference list 0 is used without signaling an inter prediction index inter_pred_idc; when reference list 0 and reference list 1 for the current block are different, the inter prediction index inter_pred_idc is signaled to indicate which list is used for the current block.

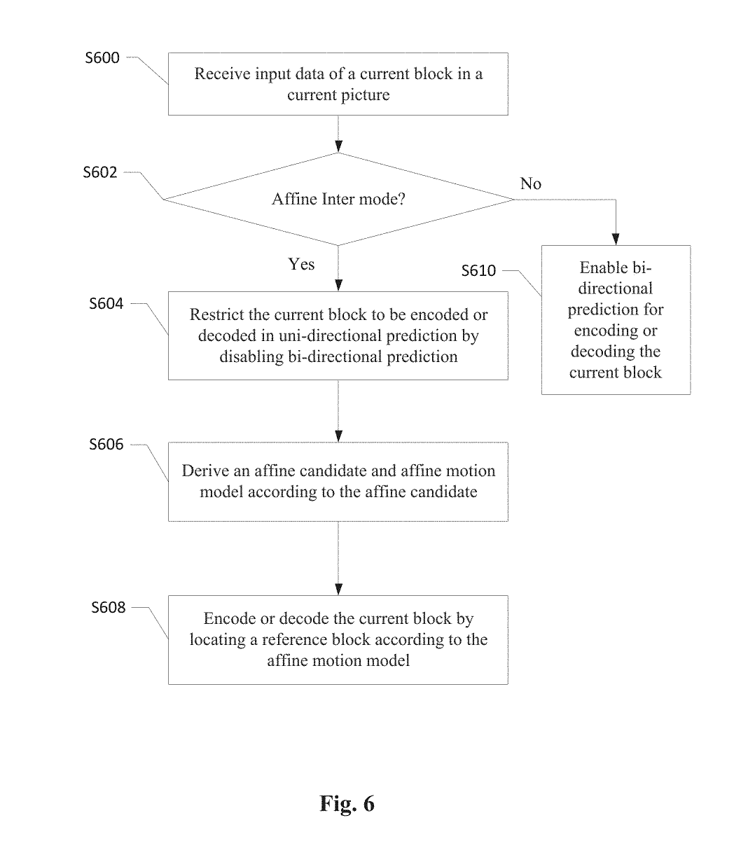

FIG. 6 illustrates an exemplary flowchart for a video coding system with affine Inter prediction incorporating an embodiment of the present invention, where bi-directional prediction is disabled depending on whether the affine Inter mode is selected. The input data related to a current block is received at a video encoder side or a video bitstream corresponding to compressed data including the current block is received at a video decoder side in step 600. Step 602 checks whether affine Inter mode is used to encode or decode the current block. If affine Inter mode is selected to code the current block, the video coding system restricts the current block to be encoded or decoded in uni-directional prediction by disabling bi-directional prediction in step 604; else the video coding system enables bi-directional prediction for encoding or decoding the current block in step 610. An affine candidate is derived if the current block is encoded or decoded in affine Inter mode, and an affine motion model is derived according to the affine candidate in step 606. The affine candidate is derived from one or more neighboring coded blocks of the current block, and if any neighboring coded block is bi-directional predicted, only one motion vector in one list is used to derive the corresponding affine motion vector. The affine candidate in one embodiment includes two affine motion vectors and the affine candidate in another embodiment includes three affine motion vectors. In step 608, the current block is encoded or decoded by locating a reference block according to the affine motion model derived in step 606.

Various embodiments of the affine Inter prediction methods may be implemented in the Video Encoder 400 in FIG. 4 or the Video Decoder 500 in FIG. 5. The Encoder 400 and the Decoder 500 may further incorporate Inter Prediction by either sharing at least a portion of the component with Affine Prediction 412 or 514 or having an additional component in parallel with Intra Prediction 410 or 512 and Affine Prediction 412 or 514. For example, when a unified Merge candidate list is used for both affine Merge mode and regular Merge mode, Affine Merge Prediction 4124 shares the component with Inter Merge Prediction; and similarly, when a unified Inter candidate list is used for both affine Inter mode and regular AMVP mode, Affine Inter Prediction 4122 shares the component with Inter AMVP Prediction. In this example, a single merge index or an MVP index may be signaled to indicate the use of affine mode or regular Inter mode.

The above described affine motion derivation method, affine Merge prediction method, or affine Inter prediction method can be implemented using a simplified affine motion model, for example, two control points are used instead of three control points. An exemplary simplified affine motion model still uses the same mathematical equations for affine motion model but derives the affine motion vector Mv2 for a lower-left control point by the affine motion vectors Mv0 and Mv1. Alternatively, the affine motion vector Mv1 for an upper-right control point may be derived by the affine motion vectors Mv0 and Mv2, or the affine motion vector Mv0 for an upper left control point may be derived by the affine motion vectors Mv1 and Mv2.

Embodiments of the affine motion derivation method, affine Merge prediction method, or affine Inter prediction method may be implemented in a circuit integrated into a video compression chip or program code integrated into video compression software to perform the processing described above. For examples, the affine motion derivation method, affine Merge prediction method, or affine Inter prediction method may be realized in program code to be executed on a computer processor, a Digital Signal Processor (DSP), a microprocessor, or field programmable gate array (FPGA). These processors can be configured to perform particular tasks according to the invention, by executing machine-readable software code or firmware code that defines the particular methods embodied by the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing video data with affine motion compensation in a video coding system, comprising:
receiving input data associated with a current block in a current picture;
if the current block is coded or to be coded in affine Merge mode, deriving a first affine Merge candidate for the current block including three affine motion vectors Mv0, Mv1, and Mv2 for predicting motion vectors at control points of the current block, wherein Mv0 is derived from a motion vector of a first neighboring coded block of the current block, Mv1 is derived from a motion vector of a second neighboring coded block of the current block, and Mv2 is derived from a motion vector of a third neighboring coded block of the current block;
if the first affine Merge candidate is selected to encode or decode the current block, deriving an affine motion model according to the affine motion vectors Mv0, Mv1, and Mv2 of the first affine Merge candidate; and
encoding or decoding the current block by locating a reference block in a reference picture for the current block according to the affine motion model.

2. The method of claim 1, wherein the first neighboring coded block is an upper-left corner sub-block adjacent to the current block, the second neighboring coded block is a top-right sub-block above the current block, and the third neighboring coded block is a left-bottom sub-block beside the current block.

3. The method of claim 1, wherein Mv0 is a first available motion vector of motion vectors at an upper-left corner sub-block adjacent to the current block, a top-left sub-block above the current block, and a left-top sub-block beside the current block, Mv1 is a first available motion vector of motion vectors at a top-right sub-block above the current block and an upper-right corner sub-block adjacent to the current block, and Mv2 is a first available motion vector of motion vectors at a left-bottom sub-block beside the current block and a lower-left corner sub-block adjacent to the current block.

4. The method of claim 1, further comprises deriving a second affine Merge candidate including three affine motion vectors, and if the second affine Merge candidate is selected to encode or decode the current block, deriving the affine motion model according to the affine motion vectors of the second affine Merge candidate, wherein at least one affine motion vector in the second affine Merge candidate is different from the corresponding affine motion vector in the first affine Merge candidate.

5. The method of claim 4, wherein the first affine Merge candidate and the second affine Merge candidate have same first and second affine motion vectors, a third affine motion vector in the first affine Merge candidate is a motion vector at a left-bottom sub-block beside the current block, and a third affine motion vector in the second affine Merge candidate is a motion vector at a lower-left corner sub-block adjacent to the current block.

6. The method of claim 4, wherein the first affine Merge candidate and the second affine Merge candidate have same first and third affine motion vectors, a second affine motion vector in the first affine Merge candidate is a motion vector at a top-right sub-block above the current block, and a second affine motion vector in the second affine Merge candidate is a motion vector at an upper-right corner sub-block adjacent to the current block.

7. The method of claim 4, wherein the first affine Merge candidate and the second affine Merge candidate have a same first affine motion vector, a second affine motion vector in the first affine Merge candidate is a motion vector at a top-right sub-block above the current block and a second affine motion vector in the second affine Merge candidate is a motion vector at an upper-right corner sub-block adjacent to the current block, and a third affine motion vector in the first affine Merge candidate is a motion vector at a left-bottom sub-block beside the current block and a third affine motion vector in the second affine Merge candidate is a motion vector at a lower-left corner sub-block adjacent to the current block.

8. The method of claim 1, wherein the first affine Merge candidate is denoted as not exist if inter prediction directions or reference pictures of the three affine motion vectors Mv0, Mv1, and Mv2 are not all the same.

9. The method of claim 1, wherein an inter prediction direction for the first affine Merge candidate is uni-directional prediction and using only a first reference list if all the three affine motion vectors Mv0, Mv1, and Mv2 are available only in the first reference list, and the first reference list is selected from list 0 and list 1.

10. The method of claim 1, further comprising scaling the affine motion vectors Mv0, Mv1, and Mv2 in the first affine Merge candidate to a designated reference picture if reference pictures of the three affine motion vectors are not all the same.

11. The method of claim 1, further comprising scaling one of the affine motion vectors in the first affine Merge candidate to set all reference pictures of the three affine motion vectors in the first affine Merge candidate the same.

12-18. (canceled)

19. An apparatus of processing video data with affine motion compensation in a video coding system, the apparatus comprising one or more electronic circuits configured to:
receive input data associated with a current block in a current picture;
if the current block is coded or to be coded in affine Merge mode, derive a first affine Merge candidate for the current block including three affine motion vectors Mv0, Mv1, and Mv2 for predicting motion vectors at control points of the current block, wherein Mv0 is derived from a motion vector of a first neighboring coded block of the current block, Mv1 is derived from a motion vector of a second neighboring coded block of the current block, and Mv2 is derived from a motion vector of a third neighboring coded block of the current block;
if the first affine Merge candidate is selected to encode or decode the current block, derive an affine motion model according to the affine motion vectors Mv0, Mv1, and Mv2 of the first affine candidate; and
encode or decode the current block by locating a reference block in a reference picture for the current block according to the affine motion model.

20. (canceled)

21. A non-transitory computer readable medium storing program instruction causing a processing circuit of an apparatus to perform a video coding method with affine motion compensation, and the method comprising:
receiving input data associated with a current block in a current picture;
if the current block is coded or to be coded in affine Merge mode, deriving a first affine Merge candidate for the current block including three affine motion vectors Mv0, Mv1, and Mv2 for predicting motion vectors at control points of the current block, wherein Mv0 is derived from a motion vector of a first neighboring coded block of the current block, Mv1 is derived from a motion vector of a second neighboring coded block of the current block, and Mv2 is derived from a motion vector of a third neighboring coded block of the current block;
if the first affine Merge candidate is selected to encode or decode the current block, deriving an affine motion model according to the affine motion vectors Mv0, Mv1, and Mv2 of the first affine Merge candidate; and
encoding or decoding the current block by locating a reference block in a reference picture for the current block according to the affine motion model.

22. (canceled)
